(19) United States
(12) Patent Application Publication
(10) Pub. No.: US 2025/0248370 A1
(43) Pub. Date: Aug. 7, 2025

(54) BIRD CAGE FOR VIEWING

(71) Applicant: Yiwu Yundi Commodity Co., Ltd., Jinhua (CN)

(72) Inventor: QI KONG, Linxiang (CN)

(21) Appl. No.: 18/581,126

(22) Filed: Feb. 19, 2024

(30) Foreign Application Priority Data
Feb. 4, 2024 (CN) 202410152950.X

(51) Int. Cl. A01K 31/06

(52) U.S. Cl. CPC A01K 31/06

(57) ABSTRACT

The present disclosure relates to a new bird cage for viewing, including a cage body and a bottom plate. One side of the cage body is provided with an inlet and outlet, the bottom plate is movably provided at two sides of the inlet and outlet. A transparent piece is provided on one side of the cage body away from the bottom plate, a movable groove is provided on the cage body or bottom plate. A connection position between the cage body and the bottom plate is provided with a fixing piece, which is fixed on the bottom plate or cage body through the movable groove. A purpose of the present disclosure is to provide a novel bird cage for viewing to solve technical problems such as inconvenient installation, easy tilting, obstructed view, and poor stability of existing bird cages for viewing.

### CROSS-REFERENCE TO RELATED APPLICATIONS

This application claims priority to Chinese Patent Application No. 202410152950.X, filed on Feb. 4, 2024, which is hereby incorporated by reference in its entirety.

### TECHNICAL FIELD

The present disclosure relates to the technologies field of bird cage for viewing, and in particular, to a novel bird cage for viewing.

### BACKGROUND

In order to observe wild birds, a type of bird cage for viewing has emerged on the market. This type of bird cage for viewing is usually composed of a cage body and a bottom plate. One end of the cage body is provided with an inlet and outlet for a bird to enter and exit, the other side thereof is provided with an observation window made of transparent material. When using it, the bottom plate is first adjusted to a size suitable for a window size, and then upper and lower ends of the bottom plate are fixed in place according to a gap on the upper and lower window edges of the window, and at this point, the inlet and outlet of the cage body will face outdoors, and people can observe an inside of the cage body through the observation window when being in indoors. There will also be a feeding port on the cage body to attract the bird, thereby being convenient to observe.

At present, mortise and tenon structures are commonly used to connect the cage body and bottom plate of bird cage for viewing on the market to achieve an adjustable function of the bottom plate. However, a connection mode of mortise and tenon structures has many defects:

1. Multiple calibrations are required during an installation process, which is extremely inconvenient to install.

2. The form of mortise and tenon connection cannot be too tight, which can render it difficult to pull the bottom plate. Therefore, it is necessary to reserve a gap between the cage body and the bottom plate to facilitate the pulling of the bottom plate. However, during use, due to the gap between the cage body and the bottom plate and the presence of gravity, the cage body gradually tilts relative to the bottom plate, thereby leading to an internal water accumulation.

3. In order to fix a distance between an upper cover plate and a lower bottom plate of the existing cage, a column is usually installed between the upper cover plate and the lower bottom plate, which leads to obstructed visibility during viewing.

4. An overall firmness of the mortise and tenon connection is not high and is prone to damage.

### SUMMARY

The present disclosure provides a novel bird cage for viewing to solve the above-mentioned technical problem.

To achieve the above objectives, the technical solution adopted by the present disclosure is a novel bird cage for viewing, including a cage body and a bottom plate, one side of the cage body is provided with an inlet and outlet, the bottom plate is movably provided on two sides of the inlet and outlet; one side of the cage body far from the bottom plate is provided with a transparent piece, a movable groove is provided on the cage body or the bottom plate, a fixing piece is provided at a connection position between the cage body and the bottom plate, the fixing piece is fixed on the bottom plate or cage body through the movable groove.

In an embodiment of the present disclosure, the cage body includes an upper cover plate and a lower bottom plate, several positioning columns are provided between the upper cover plate and the lower bottom plate, sides of the upper cover plate and the lower bottom plate far from the bottom plate, as well as the positioning columns are respectively provided with clamp slots that correspond with each other; the transparent piece is provided in the clamp slots.

In an embodiment of the present disclosure, the fixing piece is a bolt, which is fixed in a fixing hole provided on the bottom plate or the cage body through the movable groove on the cage body or the bottom plate.

In an embodiment of the present disclosure, the upper cover plate and the lower bottom plate respectively extend upwards and downwards to form an installation part, the movable groove or fixing holes are provided on two sides of the installation part, a position of the bottom plate corresponding to the movable groove or fixing hole is provided with the fixing hole or movable groove, an upper and lower ends of the bottom plate are movably provided on the installation part through the fixing piece.

In an embodiment of the present disclosure, an inner of the movable groove is distributed in a stepped shape, the movable groove includes a slot configured to fix and move the fixing piece, a first step configured to clamp a screw cap at an end of a bolt, and a second step configured to install a rubber sealing strip.

In an embodiment of the present disclosure, a gap is formed between the cage body and the bottom plate, a blocking plate is movably provided in the gap.

In an embodiment of the present disclosure, an upper end of the cage body is provided with a suspension part, the suspension part is detachably provided with a curtain.

In an embodiment of the present disclosure, an upper surface of the cage body is provided with a feeding port and a water collector port, a water collector is provided in the water collector port, a cover body is provided on the feeding port.

In an embodiment of the present disclosure, a bird stopping rod is provided between two walls of the cage body.

In an embodiment of the present disclosure, the cage body is in a shape of curve, square or fan.

Through the above technical solution, the present disclosure has the following beneficial effects compared to prior art: by providing with a movable groove on the cage or bottom plate, and providing with a fixing piece in the movable groove, the fixing piece passes through the movable groove, one end of the fixing piece is clamped in the movable groove of the cage body or bottom plate, the other end thereof is fixed on the bottom plate or cage body, a gap between the bottom plates is adjusted in a way that the movable groove is movable relative to the fixing piece, this solution has the following advantages:

1. The cage body or bottom plate is tightly fitted, during an installation, only one side needs to be aligned to achieve alignment between the upper and lower ends, an installation is easy.

2. The cage body or bottom plate is connected by the movable groove and the fixing piece. The fixing piece passes through the movable groove on the cage body or bottom plate and is directly fixed vertically to the bottom plate or cage body on the other side. This connection method achieves the movement of the bottom plate through a relative movement of the fixing piece and the movable groove. Therefore, even if the cage body and bottom plate are in a seamless state, there will be no situation where the bottom plate cannot be pulled or moved. Thus, the cage body will not tilt relative to the bottom plate, effectively preventing the technical problem of water accumulation on an inner side of the cage body when it tilts.

3. An original column has been removed to provide a wider view.

4. Compared to mortise and tenon structures, an overall stability and durability of the connection are stronger with fixing piece.

### BRIEF DESCRIPTION OF DRAWINGS

In order to provide a clearer explanation of the embodiments of the present disclosure or the technical solutions in the prior art, a brief introduction will be given below to the drawings required in the embodiments or prior art description. It is obvious that the drawings in the following description are only some embodiments of the present disclosure. For those skilled in the art, other drawings can be obtained based on the structures shown in these drawings without creative work.

FIG. 1 is an exploded view of the present disclosure.

FIG. 2 is a diagram of a connection state of a movable groove and a fixing piece of the present disclosure.

FIG. 3 is a structural schematic diagram of a front view of a first embodiment of the present disclosure.

FIG. 4 is a structural schematic diagram of a bottom view of the first embodiment of the present disclosure.

FIG. 5 is a structural schematic diagram of a front view of a second embodiment of the present disclosure.

FIG. 6 is a structural schematic diagram of a top view of the second embodiment of the present disclosure.

FIG. 7 is a structural schematic diagram of a bottom view of the second embodiment of the present disclosure.

FIG. 8 is a structural schematic diagram of a rear view of the second embodiment of the present disclosure.

FIG. 9 is a schematic diagram of an internal structure of the second embodiment of the present disclosure.

FIG. 10 is a structural schematic diagram of a front view of a third embodiment of the present disclosure.

FIG. 11 is a schematic diagram of a connection state of a bird stopping rod in the third embodiment of the present disclosure.

FIG. 12 is a structural schematic diagram of a front view of a fourth embodiment of the present disclosure.

FIG. 13 is a structural schematic diagram of a front view of a fifth embodiment of the present disclosure.

FIG. 14 is a structural schematic diagram of a front view of a sixth embodiment of the present disclosure.

Numeral reference: 1. Cage body; 2. Bottom plate; 3. Movable groove; 4. Transparent piece; 5. Fixing piece; 6. Fixing hole; 7. Installation part; 8. Rubber sealing strip; 9. Blocking plate; 10. Suspension part; 11. Curtain; 12. Feeding port; 13. Water collector port; 14. Cover body; 15. Bird stopping rod; 16. Water collector; 101. Upper cover plate; 102. Lower bottom plate; 103. Positioning column; 104. Clamp slot; 301. Slot; 302. First step; 303. Second step.

The implementation, functional characteristics, and advantages of the present disclosure will be further explained in combination with embodiments, with reference to the drawings.

### DESCRIPTION OF EMBODIMENTS

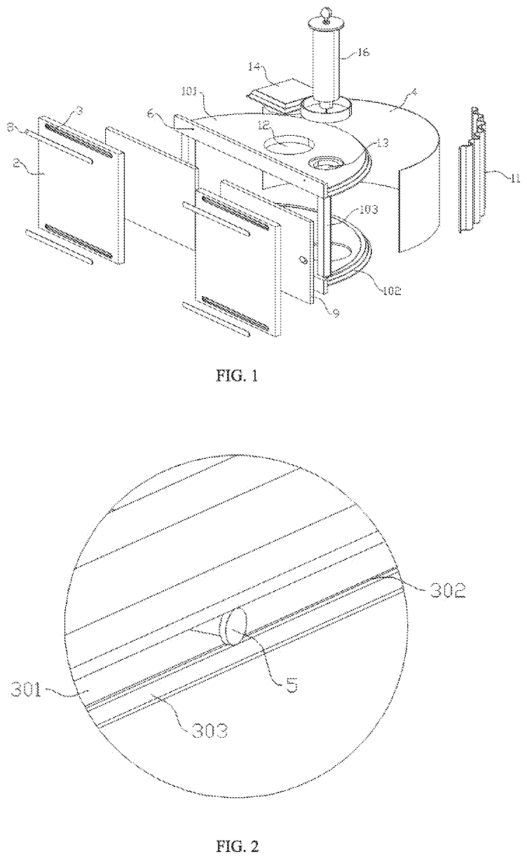

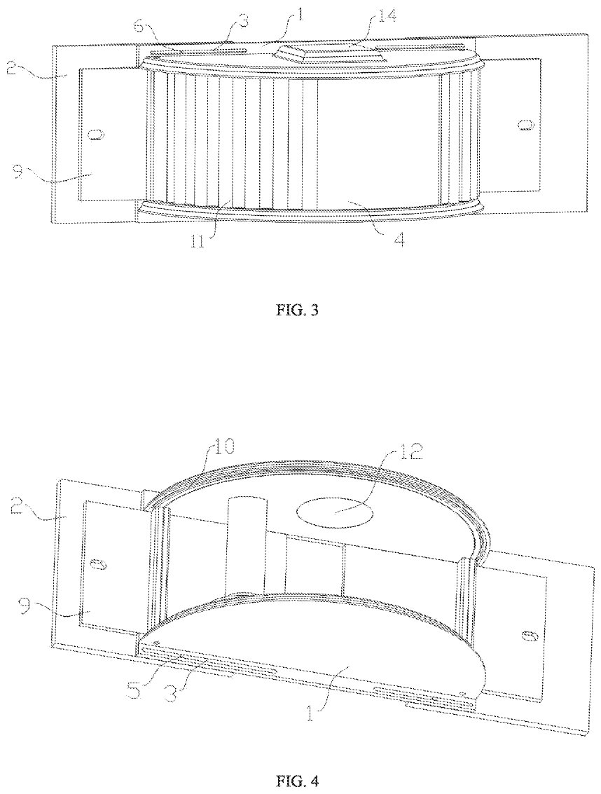

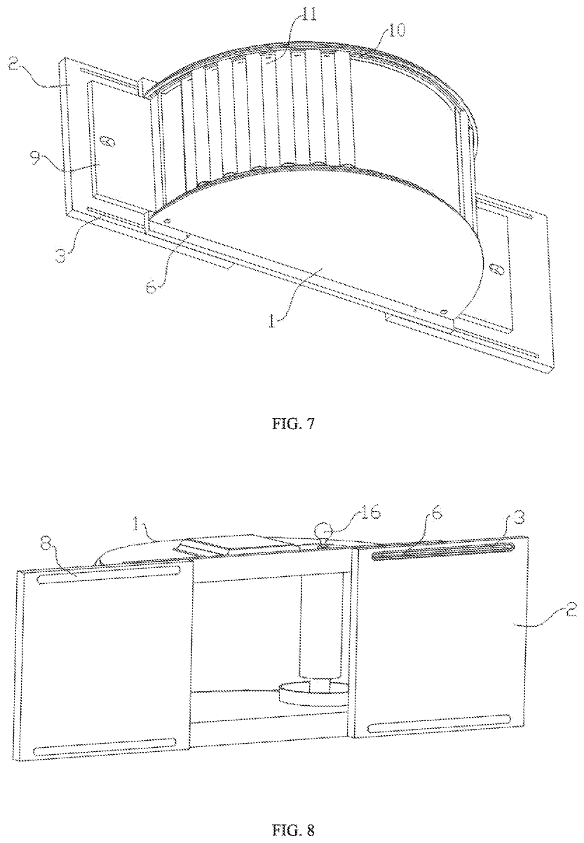

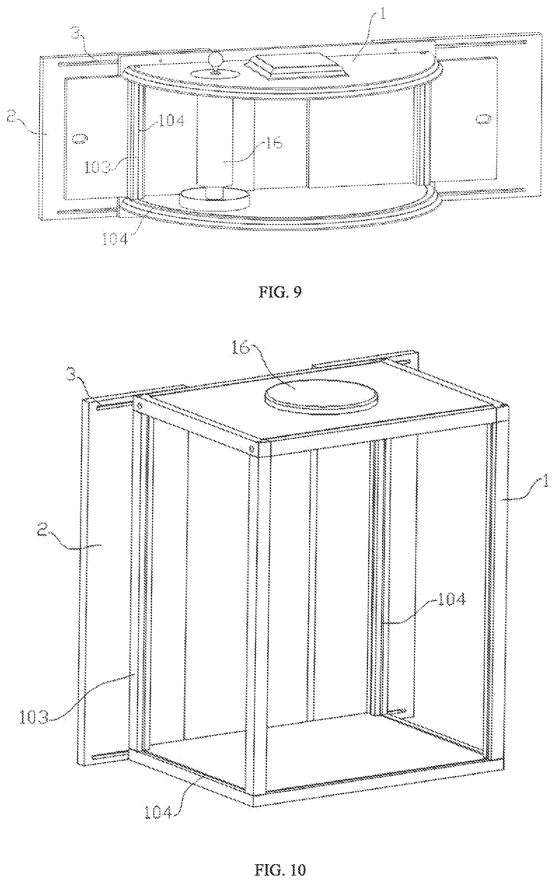

The following will provide a clear and complete description of the technical solution in the embodiments of the present disclosure, in combination with FIGS. 1-14. Obviously, the described embodiments are only a part of the embodiments of the present invention, not all of them. Based on the embodiments in the present disclosure, all other embodiments obtained by ordinary technicians in the art without creative work fall within the protection scope of the present disclosure.

It should be noted that all directional indications (such as up, down, left, right, front, back . . . ) in the embodiments of the present disclosure are only used to explain a relative position relationship and motion situation between components in a specific posture (as shown in the figure). If the specific posture changes, the directional indication also changes accordingly.

In addition, the description of “first”, “second”, etc. in the present disclosure is only for a purpose of description and cannot be understood as indicating or implying their relative importance or implying the number of indicated technical features. Therefore, the features limited to “first” and “second” can explicitly or implicitly include at least one of these features. In addition, the technical solutions between various embodiments can be combined with each other, but must be based on what ordinary technicians in the art can achieve. When the combination of technical solutions is contradictory or impossible to achieve, it should be considered that the combination of such technical solutions does not exist and is not within the protection scope of required by the present disclosure.

A first embodiment of the present disclosure, as shown in FIGS. 1-4: a novel bird cage for viewing, including a cage body 1 and a bottom plate 2. One side of the cage body 1 is provided with an inlet and outlet, one side of the cage body 1 away from the inlet and outlet and located indoors is an arc shape. The bottom plate 2 is movably provided on two sides of the inlet and outlet, a transparent piece 4 is provided on one side of the cage body 1 away from the bottom plate 2. A movable groove 3 is provided on the cage body 1, a fixing piece 5 is provided at a connection position between the cage body 1 and the bottom plate 2, the fixing piece 5 is fixed to the bottom plate 2 through the movable groove 3, which is a bolt. The bolt is fixed to a fixing hole 6 provided on the bottom plate 2 through the movable groove 3 on the cage body 1. The fixing hole 6 is correspondingly provided with the movable groove 3, one end of the bolt passes through the movable groove 3 and is fixed in the fixing hole 6, while the other end of the bolt is provided with a nut. A diameter of the nut is larger than a width of the movable groove 3. Therefore, when the bolt is fixed in the fixing hole 6. The bottom plate 2 will be fixed to the cage body 1 through the nut, and the bottom plate 2 will be provided on two sides of the inlet and outlet. An upper and lower sides of the bottom plate 2 are connected to the fixing piece 5 through the movable groove 3. When in use, by pulling the bottom plate 2, the bottom plate 2 will drive the fixing piece 5 on it to move horizontally along the movable groove 3, thereby achieving a purpose of adjusting a spacing.

As shown in FIG. 1, the cage body 1 includes an upper cover plate 101 and a lower bottom plate 102. Several positioning columns 103 are provided between the upper cover plate 101 and the lower bottom plate 102. The positioning columns 103 are provided with two and are distributed on two sides of the cage body 1. The positioning columns 103 are fixed between the upper cover plate 101 and the lower bottom plate 102 by threading. One sides of the upper cover plate 101 and the lower bottom plate 102 away from the bottom plate 2, as well as the corresponding clamp slots 104 are provided on the positioning columns 103. The transparent piece 4 is provided in the clamp slot 104, transparent piece 4 is a curved plate made of PVC material, through which an interior of the cage body can be directly observed.

As shown in FIG. 2, the movable groove 3 is distributed in a shape of step. The movable groove 3 includes a groove 301 configured to fix and move the fixing piece 5, a first step 302 configured to clamp a screw cap on an end of a bolt, a second step 303 configured to install a rubber sealing strip 8. The stepped design increases an overall practicality, the sealing strip can be clamped on the second step 303 to cover a connection between the cage body and the bottom plate, thereby increasing an aesthetic level.

As shown in FIGS. 1-4, a gap is formed between the cage body 1 and the bottom plate 2, a blocking plate 9 is movably provided in the gap. By providing with the blocking plate 9, when the bird cage is not in use, in order to avoid indoor observation from the outside, the inlet and outlet are closed by pushing the blocking plate 9 to close each other on two sides, increasing privacy. When it is needed, the blocking plate 9 on two sides are simply pulled, and a handle hole is provided on the blocking plate 9 for easy pulling, which is very convenient.

As shown in FIG. 4, an upper end of the cage body 1 is provided with a suspension part 10, a detachable curtain 11 is provided on the suspension part 10. The suspension part 10 is arranged along a circumference of the cage body 1, which is in an arc shape. The suspension part 10 is provided on an outside of the clamp slot 104. In order to not block the line of sight, the suspension part 10 is provided in the groove specially provided by a door of the cage body 1. The suspension part 10 is fixed at a top of the cage body 1 through connection pieces on two sides, the curtain 11 is provided on the suspension part 10, and it can move along a curved direction of the suspension part 10, and by providing with the curtain 11, it can block the line of sight and protect privacy when not using the birdcage.

As shown in FIG. 1, an upper surface of the cage body 1 is provided with a feeding port 12 and a water collector port 13. The water collector port 13 is provided with a water collector 16, the feeding port 12 is provided with a cover body 14. The water collector port 13 is vertically placed in the water collector port 13, a water bowl for a bird to drink water is provided at an outlet of the water collector 16. The feeding port 12 is located at a middle of the cage body 1, used to place bird food to attract the bird to come and observe better.

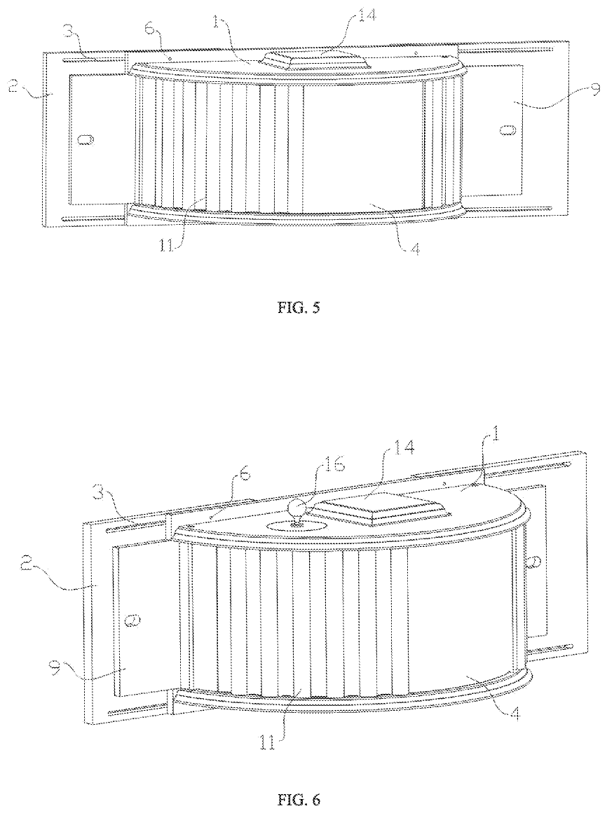

At the same time, the cage body 1 can also be placed directly outdoors. In the cage body 1, potted plants, green plants, etc. can be placed according to customer needs as a sunlight room to increase the functionality of the bird cage and meet certain customer needs. The difference between a second embodiment and the first embodiment of the present disclosure is that as shown in FIGS. 5-9, a novel bird cage for viewing includes a cage body 1 and a bottom plate 2. One side of the cage body 1 is provided with an inlet and outlet, one side of the cage body 1 away from the inlet and outlet and located indoors is curved. The bottom plate 2 is movably provided on two sides of the inlet and outlet, a transparent piece 4 is provided on one side of the cage body 1 away from the bottom plate 2. A movable groove 3 is provided on the bottom plate 2. A connection between cage body 1 and bottom plate 2 is provided with a fixing piece 5, which is fixed on the cage body 1 through the movable groove 3. The fixing piece 5 is a bolt, the bolt is fixed in a fixing hole 6 provided on the cage body 1 through the movable groove 3 on bottom plate 2. The fixing hole 6 is corresponding to the movable groove 3, one end of the bolt passes through the movable groove 3 and is fixed in the fixing hole 6. The other end of the bolt is provided with a nut, a diameter of the nut is greater than a width of the movable groove 3. Therefore, when the bolt is fixed in the fixing hole 6, the bottom plate 2 will be fixed on the cage body 1 through the nut, the bottom plate 2 will be provided on two sides of the inlet and outlet. An upper and lower sides of the bottom plate 2 are connected to the fixing piece 5 through the movable groove 3. When in use, by pulling the bottom plate 2, the movable groove 3 on the bottom plate 2 will move relative to the fixing piece 5, thereby achieving a purpose of adjusting the spacing, the second embodiment has the same technical features as the first embodiment, except for the aforementioned distinguishing features.

The difference between a third embodiment and the first embodiment of the present disclosure is as shown in FIG. 10: a novel bird cage for viewing, including a cage body 1 and a bottom plate 2. One side of the cage body 1 is provided with an inlet and outlet, one side of the cage body 1 away from the inlet and outlet is a rectangle. The bottom plate 2 is movably provided on two sides of the inlet and outlet, a rectangular transparent piece 4 is provided on one side of the cage body 1 away from the bottom plate 2. The rectangular transparent piece 4 is distributed on two sides of the bottom surface. On the bottom plate 2, there is a movable groove 3, at a connection position between the cage body 1 and the bottom plate 2, a fixing piece 5 is provided. The fixing piece 5 is fixed on the cage body 1 through the movable groove 3, the fixing piece 5 is a bolt. The bolt is fixed in the fixing hole 6 provided on the cage body 1 through the movable groove 3 on the bottom plate 2, the fixing hole 6 corresponds to the movable groove 3. One end of the bolt passes through the movable groove 3 and is fixed in the fixing hole 6, the other end of the bolt is provided with a nut, a diameter of the nut is greater than a width of the movable groove 3. Therefore, when the bolt is fixed in the fixing hole 6, the bottom plate 2 will be fixed on the cage body 1 through the nut, and the bottom plate 2 is provided on two sides of the inlet and outlet. The upper and lower sides of the bottom plate 2 are connected to the fixing piece 5 through the movable groove 3. When in use, by pulling the bottom plate 2, the movable groove 3 on the bottom plate 2 will move relative to the fixing piece 5, thereby achieving the purpose of adjusting the spacing.

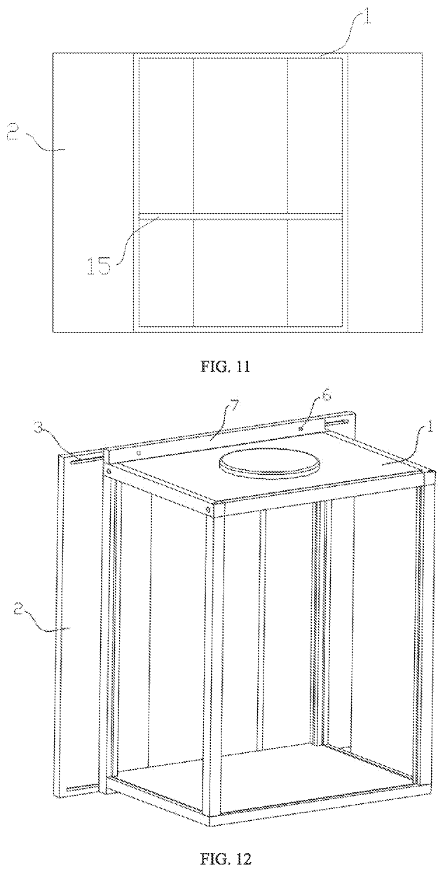

As shown in FIG. 11, a bird stopping rod 15 is provided between two sides of the cage body 1. The bird stopping rod 15 is fixed between the two sides of the cage body 1 through a threaded fixing mode, the bird stopping rod 15 is provided for a bird to play and inhabit. The third embodiment has the same technical features as the first embodiment, except for the aforementioned distinguishing features.

The difference between a fourth embodiment and the first embodiment of the present disclosure is as shown in FIG. 12: a novel bird cage for viewing, including a cage body 1 and a bottom plate 2. One side of the cage body 1 is provided with an inlet and outlet, one side of the cage body 1 away from the inlet and outlet is rectangular, the bottom plate 2 is movably provided on two sides of the inlet and outlet, one side of the cage body 1 away from the bottom plate 2 is provided with a transparent piece 4, a connection position between the cage body 1 and the bottom plate 2 is provided with a fixing piece 5. The cage body 1 includes an upper cover plate 101 and a lower bottom plate 102. Several positioning columns 103 are provided between the upper cover plate 101 and the lower bottom plate 102. Corresponding clamp slots 104 are provided on one sides of the upper cover plate 101 and the lower bottom plate 102 away from the bottom plate 2, and on the positioning column 103. Transparent pieces 4 are provided in the clamp slots 104. The upper cover plate 101 and the lower bottom plate 102 extend upwards and downwards to form an installation part 7. Fixing holes 6 are provided on two sides of the installation part 7, the movable grooves 3 are provided on the bottom plate 2. Upper and lower ends of the bottom plate 2 are fixed in the fixing hole 6 of the installation part 7 through the fixing piece 5, and the fixing piece 5 is fixed on the installation part 7 of the cage body 1 through the movable groove 3. The fourth embodiment has the same technical features as the first embodiment, except for the aforementioned distinguishing features.

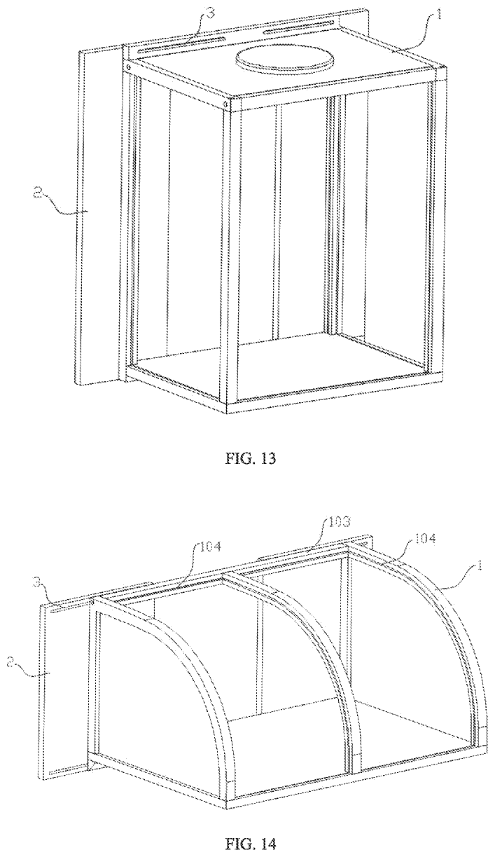

The difference between a fifth embodiment and the first embodiment of the disclosure is as shown in FIG. 13: a novel bird cage for viewing, including a cage body 1 and a bottom plate 2. One side of the cage body 1 is provided with an inlet and outlet, one side of the cage body 1 away from the inlet and outlet is rectangular, the bottom plate 2 is movably provided on two sides of the inlet and outlet, one side of the cage body 1 away from the bottom plate 2 is provided with a transparent piece 4, a connection position between the cage body 1 and the bottom plate 2 is provided with a fixing piece 5. The cage body 1 includes an upper cover plate 101 and a lower bottom plate 102. Several positioning columns 103 are provided between the upper cover plate 101 and the lower bottom plate 102. Corresponding clamp slots 104 are provided on the sides of the upper cover plate 101 and the lower bottom plate 102 away from the bottom plate 2, as well as on the positioning column 103. Transparent pieces 4 are provided in the clamp slots 104. The upper cover plate 101 and the lower bottom plate 102 extend upwards and downwards to form an installation part 7, and movable grooves 3 are provided on two sides of the installation part 7. A fixing hole 6 is provided at a position corresponding to the movable groove 3 on the bottom plate 2. An upper and lower end of the bottom plate 2 are fixedly provided in the movable groove 3 of the installation part 7 through the fixing piece 5, and the fixing piece 5 is fixed in the fixing hole 6 of the bottom plate 2 through the movable groove 3 on the installation part 7. The fifth embodiment has the same technical features as the first embodiment, except for the aforementioned distinguishing features.

A sixth embodiment of the present disclosure, the difference between the sixth embodiment and the first embodiment, is as shown in FIG. 14: a novel bird cage for viewing, including a cage body 1 and a bottom plate 2. One side of the cage body 1 is provided with an inlet and outlet, one side of the cage body 1 away from the inlet and outlet and located indoors is fan-shaped, the bottom plate 2 is movably provided on two sides of the inlet and outlet, one side of the cage body 1 away from the bottom plate 2 is provided with a transparent piece 4. A fan-shaped transparent piece 4 includes two rectangular side transparent panels and two arc-shaped transparent panels located in a middle position. The bottom plate 2 is provided with a movable groove 3, a fixing piece 5 is provided at a connection between the cage body 1 and the bottom plate 2. The fixing piece 5 is fixed to the cage body 1 through the movable groove 3, and the fixing piece 5 is a bolt. The bolt is fixed to the fixing hole 6 provided on the cage body 1 through the movable groove 3 on the bottom plate 2, and the fixing hole 6 and the movable groove 3 are correspondingly provided, one end of the bolt passes through the movable groove 3 and is fixed in the fixing hole 6, while the other end of the bolt is provided with a nut. A diameter of the nut is larger than a width of the movable groove 3. Therefore, when the bolt is fixed in the fixing hole 6, the bottom plate 2 will be fixed on the cage body 1 through the nut. At the same time, the bottom plate 2 is provided on two sides of the inlet and outlet, and the upper and lower sides of the bottom plate 2 are connected to the fixing piece 5 through the movable groove 3. When in use, the bottom plate 2 is pulled, the movable groove 3 on the bottom plate 2 will move relative to the fixing piece to achieve the purpose of adjusting the spacing. The cage body 1 is composed of a lower bottom surface and several connection rods arranged in an arc shape on the lower bottom surface. One end of the arc connection rod is provided with a positioning column 103 configured to install the upper side of the bottom plate 2, one side of the lower bottom surface is directly provided with a fixing hole for installing the bottom plate 2 on a lower bottom surface. An inner side of the positioning column 103 and the arc-shaped connection rod are both provided with a clamp slot 104 for clamping the arc-shaped transparent piece. The sixth embodiment has the same technical features as the first embodiment except for the above distinguishing features.

In summary, the beneficial effects of the present disclosure are as follows:

By providing with a movable groove on the cage body or bottom plate and providing with a fixing piece in the movable groove, the fixing piece passes through the movable groove, one end of the fixing piece is clamped in the movable groove of the cage body or bottom plate, while the other end thereof is fixed on the bottom plate or cage body, a spacing between side bottom plates is adjusted in a way that the movable groove is relative to the fixing piece. This method has the following advantages: 1. The cage body 1 or the bottom plate 2 are tightly fitted, during an installation, only one side needs to be aligned to achieve alignment between the upper and lower ends, rendering the installation is easier; 2. cage body 1 or bottom plate 2 is connected by a movable groove 3 and a fixing piece 5. The fixing piece passes through the movable groove 3 on the cage body 1 or bottom plate 2 and is directly fixed vertically to the bottom plate 2 or cage body 1 on the other side. This connection method achieves the movement of the bottom plate through a relative movement of the fixing piece 5 and the movable groove 3. Therefore, even if the cage body 1 and bottom plate 2 are in a seamless state, there will be no situation where the bottom plate cannot be pulled. Thus, the cage body will not tilt relative to the bottom plate, effectively preventing the technical problem of water accumulation on the inner side when the cage body tilts; 3. An original column has been removed to provide a wider view; 4. compared to mortise and tenon structures, the connection method of the fixing piece 5 is more solid and durable.

The above is only a preferred embodiment of the present disclosure and does not limit the scope of the present disclosure. Any equivalent structural changes made using the description and drawings of the present disclosure, or directly/indirectly applied in other related technical fields, are included in the protection scope of the present disclosure.

What is claimed is:

1. A novel bird cage for viewing, comprising a cage body (1) and a bottom plate (2), wherein one side of the cage body (1) is provided with an inlet and outlet, the bottom plate (2) is movably provided on two sides of the inlet and outlet; one side of the cage body (1) far from the bottom plate (2) is provided with a transparent piece (4), a movable groove (3) is provided on the cage body (1) or the bottom plate (2), a fixing piece (5) is provided at a connection position between the cage body (1) and the bottom plate (2), the fixing piece (5) is fixed on the bottom plate (2) or cage body (1) through the movable groove (3).

2. The novel bird cage for viewing according to claim 1, wherein the cage body (1) comprises an upper cover plate (101) and a lower bottom plate (102), wherein several positioning columns (103) are provided between the upper cover plate (101) and the lower bottom plate (102), sides of the upper cover plate (101) and the lower bottom plate (102) far from the bottom plate (2), as well as the positioning columns (103) are respectively provided with clamp slots (104) that correspond with each other; the transparent piece (4) is provided in the clamp slots (104).

3. The novel bird cage for viewing according to claim 1, wherein the fixing piece (5) is a bolt, which is fixed in a fixing hole (6) provided on the bottom plate (2) or the cage body (1) through the movable groove (3) on the cage body (1) or the bottom plate (2).

4. The novel bird cage for viewing according to claim 2, wherein the upper cover plate (101) and the lower bottom plate (102) respectively extend upwards and downwards to form an installation part (7), the movable groove (3) or fixing holes (6) are provided on two sides of the installation part (7), a position of the bottom plate (2) corresponding to the movable groove (3) or fixing hole (6) is provided with the fixing hole (6) or movable groove (3), an upper and lower ends of the bottom plate (2) are movably provided on the installation part (7) through the fixing piece (5).

5. The novel bird cage for viewing according to claim 3, wherein an inner of the movable groove (3) is distributed in a stepped shape, the movable groove (3) comprises a slot (301) configured to fix and move the fixing piece (5), a first step (302) configured to clamp a screw cap at an end of a bolt, and a second step (303) configured to install a rubber sealing strip (8).

6. The novel bird cage for viewing according to claim 1, wherein a gap is formed between the cage body (1) and the bottom plate (2), a blocking plate (9) is movably provided in the gap.

7. The novel bird cage for viewing according to claim 1, wherein an upper end of the cage body (1) is provided with a suspension part (10), the suspension part (10) is detachably provided with a curtain (11).

8. The novel bird cage for viewing according to claim 1, wherein an upper surface of the cage body (1) is provided with a feeding port (12) and a water collector port (13), wherein a water collector (16) is provided in the water collector port (13), a cover body (14) is provided on the feeding port (12).

9. The novel bird cage for viewing according to claim 1, wherein a bird stopping rod (15) is provided between two walls of the cage body (1).

10. The novel bird cage for viewing according to claim 1, wherein the cage body (1) is in a shape of curve, square or fan.
